(19) United States
(12) Patent Application Publication
(10) Pub. No.: US 2022/0101394 A1
(43) Pub. Date: Mar. 31, 2022

(54) MOBILE TERMINAL, PRICE ASSESSMENT SYSTEM, AND COMPUTER READABLE RECORDING MEDIUM

(71) Applicant: TOYOTA JIDOSHA KABUSHIKI KAISHA, Toyota-shi (JP)

(72) Inventors: Yuta OCHIAI, Yokohama-shi (JP); Takayuki YAMABE, Nagoya-shi (JP)

(73) Assignee: TOYOTA JIDOSHA KABUSHIKI KAISHA, Toyota-shi (JP)

(21) Appl. No.: 17/401,454

(22) Filed: Aug. 13, 2021

(30) Foreign Application Priority Data
Sep. 29, 2020 (JP) 2020-164081

(51) Int. Cl. G06Q 30/02

(52) U.S. Cl. CPC G06Q 30/0283

(57) ABSTRACT

A mobile terminal includes a processor including hardware, the processor being configured to: acquire, from a vehicle, price assessment information contributing to a price of the vehicle; determine, based on the price assessment information, whether an event has occurred in the vehicle; and output, in a case where the event has occurred in the vehicle, the price assessment information to a vehicle assessment server configured to assess the vehicle.

The present application claims priority to and incorporates by reference the entire contents of Japanese Patent Application No. 2020-164081 filed in Japan on Sep. 29, 2020.

### BACKGROUND

The present disclosure relates to a mobile terminal, a price assessment system, and a computer readable recording medium.

JP 2003-271851 A discloses a technique of assessing the price of a vehicle used by a user in real time via an in-vehicle communication module mounted on the vehicle used by the user. In this technique, vehicle data acquired from the vehicle by the in-vehicle communication module is transmitted, via the Internet, to a web server including a database of trade-in prices of used vehicles and a database of the used vehicles to receive an assessed price of the vehicle from the web server.

### SUMMARY

Since the in-vehicle communication module needs to have a communication function in JP 2003-271851 A, which may increase the initial cost for the in-vehicle communication module, the user has to bear the communication cost for the in-vehicle communication module, and the financial burden on the user increases.

There is a need for a mobile terminal, a price assessment system, and a computer-readable recording medium that are capable of reducing the initial cost for an in-vehicle communication module and reducing a financial burden of the communication cost on a user.

According to one aspect of the present disclosure, there is provided a mobile terminal including a processor including hardware, the processor being configured to: acquire, from a vehicle, price assessment information contributing to a price of the vehicle; determine, based on the price assessment information, whether an event has occurred in the vehicle; and output, in a case where the event has occurred in the vehicle, the price assessment information to a vehicle assessment server configured to assess the vehicle.

### BRIEF DESCRIPTION OF THE DRAWINGS

FIG. 1 is a diagram schematically illustrating a configuration of a price assessment system according to an embodiment;

FIG. 2 is a block diagram illustrating a functional configuration of a vehicle according to the embodiment;

FIG. 3 is a block diagram illustrating a functional configuration of a mobile terminal according to the embodiment;

FIG. 4 is a block diagram illustrating a functional configuration of a price assessment server according to the embodiment;

FIG. 5 is a flowchart illustrating an outline of processing performed by a mobile terminal according to the embodiment;

FIG. 6 is a diagram illustrating an example of estimation price information displayed by a mobile terminal according to the embodiment; and

FIG. 7 is a flowchart illustrating an outline of processing performed by a price assessment server according to the embodiment.

### DETAILED DESCRIPTION

Hereinafter, a price assessment system according to an embodiment will be described with reference to the drawings. The present disclosure is not limited to the following embodiment. In the following description, the same elements are denoted by the same reference signs.

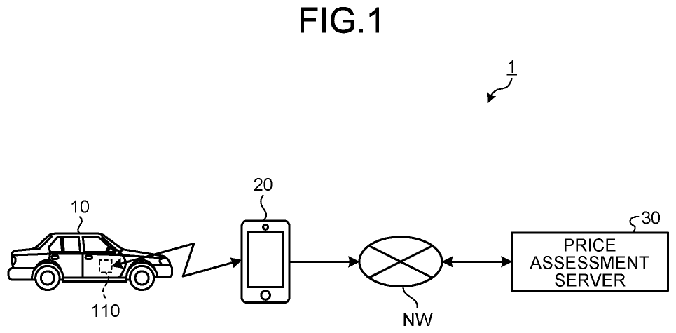

FIG. 1 is a diagram schematically illustrating a configuration of a price assessment system according to the embodiment. A price assessment system 1 illustrated in FIG. 1 includes a vehicle 10, a mobile terminal 20, and a price assessment server 30. The price assessment system 1 is configured in such a manner that the mobile terminal 20 and the price assessment server 30 may communicate with each other via a network NW. The network NW is constituted by, for example, an Internet line, a mobile phone line, and the like. In addition, in the price assessment system 1, the mobile terminal 20 and the vehicle 10 communicate with each other in accordance with a predetermined communication standard (for example, Wi-Fi (registered trademark) and Bluetooth (registered trademark)), and the mobile terminal 20 acquires price assessment information contributing to the price of the vehicle 10 and transmits the acquired price assessment information to the price assessment server 30. Then, the price assessment server 30 estimates, based on the price assessment information on the vehicle 10 received from the mobile terminal 20, estimation price information including a current price and a future price to purchase and sale the vehicle 10 and transmits the estimation price information to the mobile terminal 20, a terminal device (for example, a PC), or the like capable of purchasing and selling a used vehicle. Then, the mobile terminal 20 displays the estimation price information transmitted from the price assessment server 30. Although the mobile terminal 20 is positioned outside the vehicle 10 in FIG. 1 to describe the outline of the price assessment system 1, a user possesses and carries the mobile terminal 20 in the vehicle 10 during use. Needless to say, in the price assessment system 1, the mobile terminal 20 does not need to be positioned in the vehicle 10 as long as the mobile terminal 20 and the vehicle 10 are within a communication range in accordance with a communication standard described later.

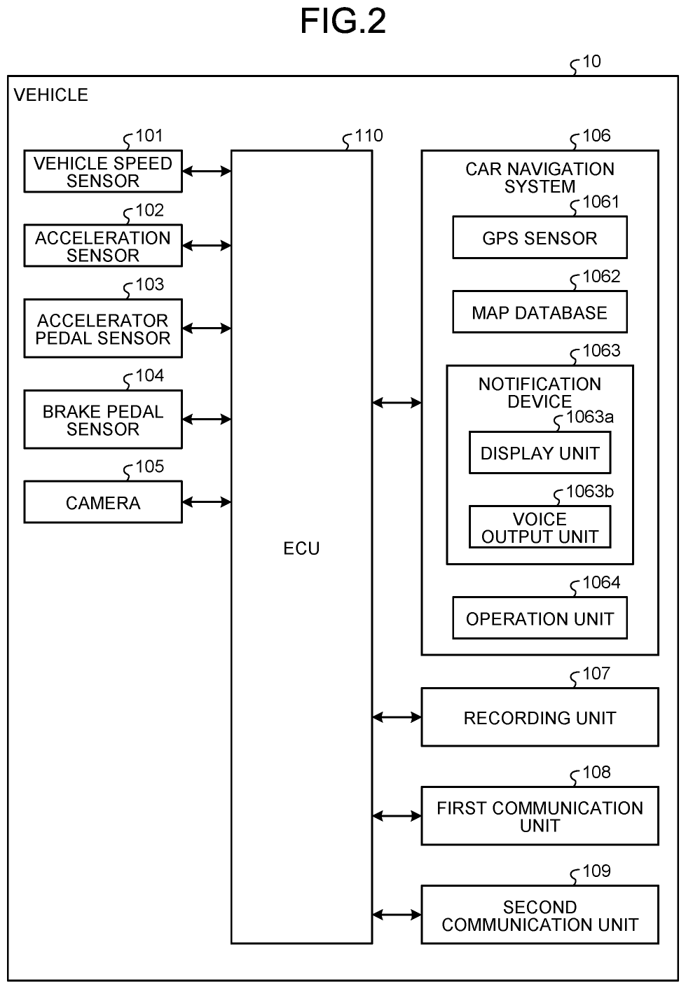

First, a functional configuration of the vehicle 10 will be described. FIG. 2 is a block diagram illustrating a functional configuration of the vehicle 10.

The vehicle 10 illustrated in FIG. 2 includes a vehicle speed sensor 101, an acceleration sensor 102, an accelerator pedal sensor 103, a brake pedal sensor 104, a camera 105, a car navigation system 106, a recording unit 107, a first communication unit 108, a second communication unit 109, and an electronic control unit (ECU) 110. In the following description, the vehicle 10 is described as a car but is not limited thereto and is applicable to, for example, a moving body. The moving body is a two wheeler, such as a motorcycle or an electric scooter, a bus, a truck, a heavy machine, a ship, a drone, or the like.

The vehicle speed sensor 101 detects the traveling speed (measured speed) when the vehicle 10 travels, and outputs the detection result to the ECU 110.

The acceleration sensor 102 detects the acceleration applied to the vehicle 10 and outputs the detection result to the ECU 110.

The accelerator pedal sensor 103 detects the depression amount of the accelerator pedal by the user and outputs the detection result to the ECU 110.

The brake pedal sensor 104 detects the depression amount of the brake pedal by the user and outputs the detection result to the ECU 110.

The camera 105 photographs the surrounding environment and the vehicle interior of the vehicle 10 to generate image data and outputs the image data to the ECU 110. A plurality of the cameras 105 is provided outside or inside the vehicle 10. Each camera 105 is implemented by an optical system, such as one or more lenses for forming a subject image, and an image sensor, such as a CCD or a CMOS, for generating image data by receiving the subject image formed by the optical system. In addition, each camera 105 photographs the surrounding environment on the exterior side (for example, 360 degrees or an environment on the rear side) of the vehicle 10 when the vehicle 10 is stopped to generate image data.

The car navigation system 106 includes a global positioning system (GPS) sensor 1061, a map database 1062, a notification device 1063, and an operation unit 1064.

The GPS sensor 1061 receives signals from a plurality of GPS satellites or transmission antennas and calculates the position (longitude and latitude) of the vehicle 10 based on the received signals. The GPS sensor 1061 is constituted by a GPS reception sensor or the like. In an embodiment, the orientation accuracy of the vehicle 10 may be improved by mounting a plurality of GPS sensors 1061.

The map database 1062 records various types of map data. The map database 1062 is constituted by a recording medium, such as a hard disk drive (HDD) or a solid state drive (SSD).

The notification device 1063 includes a display unit 1063a that displays an image, a map, a video, and character information, and a voice output unit 1063b that generates sound, such as voice or warning sound. The display unit 1063a is constituted by a display, such as liquid crystal or organic electro luminescence (EL). The voice output unit 1063b is constituted by a speaker or the like.

The operation unit 1064 receives input of user operation and outputs a signal according to each received operation content to the ECU 110. The operation unit 1064 is implemented by a touch panel, a button, a switch, a jog dial, and the like.

The car navigation system 106 having such a configuration superimposes the current position of the vehicle 10 acquired by the GPS sensor 1061 on the map corresponding to the map data recorded in the map database 1062 to notify the user of information including the road on which the vehicle 10 is currently traveling, the route to a destination, and the like with the display unit 1063a and the voice output unit 1063b.

The recording unit 107 records various types of information on the vehicle 10. The recording unit 107 records control unit area network (CAN) data of the vehicle 10 input from the ECU 110, image data generated by the camera 105, various programs to be executed by the ECU 110, and the like. The recording unit 107 is implemented by a dynamic random access memory (DRAM), a read only memory (ROM), a flash memory, a hard disk drive (HDD), a solid state drive (SSD), or the like.

Under the control of the ECU 110, the first communication unit 108 establishes communication with the mobile terminal 20 in accordance with a first communication standard and transmits price contribution information contributing to the price of the vehicle 10 including the CAN data and the image data to the mobile terminal 20. Here, the first communication standard is Wi-Fi communication capable of long-distance communication. The first communication unit 108 is implemented by a communication module capable of Wi-Fi communication.

Under the control of the ECU 110, the second communication unit 109 establishes communication with the mobile terminal 20 in accordance with a second communication standard and receives voice data and the like from the mobile terminal 20. Here, the second communication standard is Bluetooth capable of short-distance communication.

The ECU 110 is constituted by a memory and a processor having hardware, such as a central processing unit (CPU). The ECU 110 controls each unit of the vehicle 10. The ECU 110 causes the first communication unit 108 to transmit the price contribution information contributing to the price of the vehicle 10 including the CAN data of the vehicle 10 and the image data. The CAN data includes the traveling speed (measured speed), the acceleration, the depression amount of the accelerator pedal, the depression amount of the brake pedal, traveling state data of the vehicle 10, time information at which the traveling state data is detected, position information (longitude and latitude information) on the vehicle 10, vehicle model information on the vehicle 10, identification information (vehicle ID) for identifying the vehicle 10, and the like.

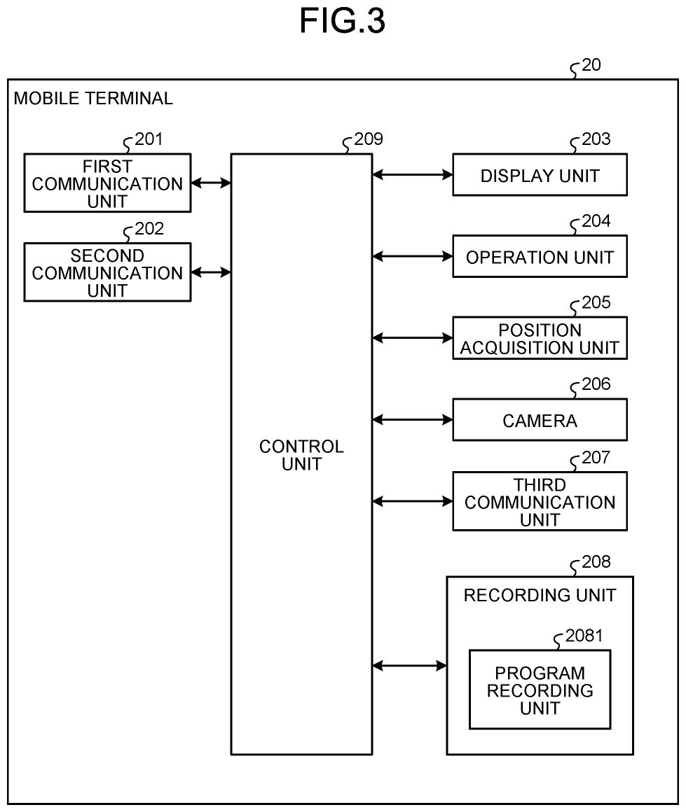

Next, a functional configuration of the mobile terminal 20 will be described. FIG. 3 is a block diagram illustrating a functional configuration of the mobile terminal 20.

The mobile terminal 20 illustrated in FIG. 3 includes a first communication unit 201, a second communication unit 202, a display unit 203, an operation unit 204, a position acquisition unit 205, a camera 206, a third communication unit 207, a recording unit 208, and a control unit 209. The mobile terminal 20 is implemented by a mobile phone, a tablet terminal, a wearable terminal, and the like.

Under the control of the control unit 209, the first communication unit 201 establishes communication with the vehicle 10 in accordance with the first communication standard, receives the price contribution information on the vehicle 10 from the vehicle 10, and outputs the price contribution information to the control unit 209. In addition, under the control of the control unit 209, the first communication unit 201 transmits, to the vehicle 10, various types of information for the vehicle 10 regarding the mobile terminal 20, such as identification information (a device address) for identifying the mobile terminal 20. The first communication unit 201 is implemented by a communication module capable of Wi-Fi communication.

Under the control of the control unit 209, the second communication unit 202 establishes communication with the vehicle 10 in accordance with the second communication standard and transmits, to the vehicle 10, various types of information, such as voice data, and the like. In addition, under the control of the control unit 209, the second communication unit 202 receives various types of information from the vehicle 10. The second communication unit 202 is implemented by a communication module capable of Bluetooth communication.

Under the control of the control unit 209, the display unit 203 displays various types of information. The display unit 203 is implemented by a display panel, such as liquid crystal or an organic EL.

The operation unit 204 receives input of various user operations and outputs a signal according to the received operation to the control unit 209. The operation unit 204 is implemented by a touch panel, a switch, a button, and the like.

The position acquisition unit 205 acquires the position of the mobile terminal 20 and outputs the acquired position to the control unit 209. The position acquisition unit 205 is implemented by a plurality of GPS receiving sensors and the like.

Under the control of the control unit 209, the camera 206 photographs a subject to generate image data and outputs the image data to the control unit 209. The camera 206 is constituted by one or a plurality of optical systems and an image sensor or the like, such as a CCD or a CMOS, for generating image data by the optical system forming and photographing a subject image.

Under the control of the control unit 209, the third communication unit 207 transmits, to the price assessment server 30, the price assessment information acquired from the vehicle 10 by the first communication unit 201 via the network NW. The third communication unit 207 transmits the price assessment information in accordance with a third communication standard different from the first communication standard and the second communication standard. Here, the third communication standard is a communication standard based on a mobile phone line and is, for example, a communication standard based on a fourth generation mobile communication system (4G), a fifth generation mobile communication system (5G), or the like. The third communication unit 207 is constituted by a communicable communication module, such as a fourth generation mobile communication system (4G), or a fifth generation mobile communication system (5G).

The recording unit 208 records various kinds of information on the mobile terminal 20 and various programs to be executed by the mobile terminal 20. The recording unit 208 includes a program recording unit 2081 that records various programs to be executed by the mobile terminal 20. The recording unit 208 is implemented by a DRAM, a ROM, a flash memory, an SSD, a memory card, or the like.

The control unit 209 includes a memory and a processor having hardware, such as a CPU. The control unit 209 acquires, from the vehicle 10, the price assessment information contributing to the price of the vehicle, determines whether an event has occurred in the vehicle 10 based on the price assessment information, and outputs, when the event has occurred in the vehicle 10, the price assessment information to the price assessment server 30 that assesses the vehicle 10. Here, the event is any of starting of the vehicle 10, stopping, sudden braking, an accident, reaching a travel distance at which the price decreases, and passing through a predetermined place. In addition, the price assessment information is any one or more pieces of travel data of the vehicle 10, CAN data, travel distance data, model year data, image data, odor data indicating an odor of a vehicle interior of the vehicle 10, scratch data as to whether there is a scratch, driving tendency data of the user of the vehicle 10, parking place data of the vehicle 10, and parking period data at the parking place. In addition, the control unit 209 estimates a driving tendency of a user of the vehicle 10 based on the CAN data included in the price assessment information. Specifically, the control unit 209 estimates the driving tendency of the user of the vehicle 10 based on the acceleration of the CAN data, the depression amount of the accelerator pedal, and the depression amount of the brake pedal. The control unit 209 further estimates a parking place of the vehicle 10 and a parking period of the vehicle 10 based on the image data included in the price assessment information. Specifically, the control unit 209 estimates the parking place of the vehicle 10 and the parking period of the vehicle 10 by performing known pattern matching or the like on the image data to extract the surrounding environment of the vehicle 10. The control unit 209 further estimates the odor data indicating an odor of the vehicle interior of the vehicle 10 by determining whether there is an animal in the vehicle interior and whether the user smokes based on the image data obtained by photographing the vehicle interior of the vehicle 10. For example, the control unit 209 detects whether there is an animal, such as a dog or a cat, in the vehicle interior or detects whether there is a cigarette by performing known pattern matching on the image data and estimates the odor data to indicate that there is an odor when the animal or the cigarette is detected. The control unit 209 further estimates the scratch data as to whether there is a scratch of the vehicle 10 by performing known pattern matching on the image data. In an embodiment, the control unit 209 functions as a first processor.

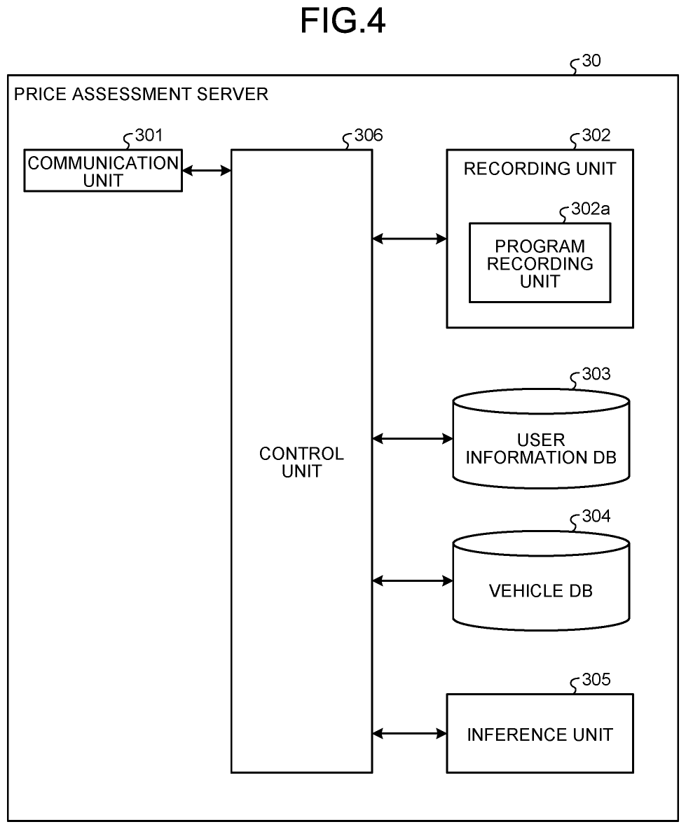

Next, a functional configuration of the price assessment server 30 will be described. FIG. 4 is a block diagram illustrating a functional configuration of the price assessment server 30.

The price assessment server 30 illustrated in FIG. 4 includes a communication unit 301, a recording unit 302, a user information database 303 (hereinafter, referred to as a “user information DB 303”), a vehicle database 304 (hereinafter, referred to as a “vehicle DB 304”), an inference unit 305, and a control unit 306.

Under the control of the control unit 306, the communication unit 301 communicates with a plurality of mobile terminals 20 via the network NW, receives the price assessment information transmitted by each mobile terminal 20, and outputs the price assessment information to the control unit 306. Under the control of the control unit 306, the communication unit 301 transmits the estimation price information on the vehicle 10 to the mobile terminal 20 that has received the price assessment information. The communication unit 301 is constituted by a communication module capable of performing communication using an Internet line.

The recording unit 302 records various types of information on the price assessment server 30. The recording unit 302 includes a program recording unit 302a that records various programs to be executed by the price assessment server 30. The recording unit 302 is implemented by a DRAM, a ROM, a flash memory, an SSD, an HDD, or the like.

The user information DB 303 records user information in which the vehicle 10, the mobile terminal 20, the name of the user who uses the vehicle 10 and the mobile terminal 20, the date of birth of the user, the address of the user, an e-mail address of the user, and a password for logging in to a service provided by the price assessment server are associated with each other. The user information DB 303 is implemented by an HDD, an SSD, and the like. Note that, the user information is registered in advance by the user logging in to the price assessment server 30 via the mobile terminal 20 or the like.

The vehicle DB 304 records vehicle information in which the model name of the vehicle 10 used by each user registered in advance by each user, the name of the user of the vehicle 10, the vehicle inspection information on the vehicle 10, the model year of the vehicle 10, the price assessment information on the vehicle 10, and the estimation price information are associated with each other. The vehicle DB 304 is implemented by an HDD, an SSD, and the like.

Under the control of the control unit 306, the inference unit 305 uses the price assessment information on the vehicle 10 as input data and outputs, as the inference result, estimation price information including the current price of the vehicle 10 and a future price based on the use tendency of the user as output data. Specifically, the inference unit 305 is constituted by a memory and a processor having hardware, such as a graphics processing unit (GPU) or a field-programmable gate array (FPGA). In addition, under the control of the control unit 306, the inference unit 305 reads a learned model stored in the memory, inputs the price assessment information on the vehicle 10 to the read learned model as input data, and outputs the estimation price information as output data. The learned model is formed using, for example, a deep neural network (DNN) as machine learning. Note that, the network type of the DNN may be any type that may be used by the inference unit 305. Specifically, the type of machine learning is not particularly limited and is sufficient as long as it performs learning by, for example, preparing training data or learning data in which the price assessment information and the estimation price information are associated with each other and inputting the training data or learning data to a calculation model based on a multilayer neural network. In addition, as a method of machine learning, a method based on a DNN of a multilayer neural network, such as a convolutional neural network (CNN) or a 3D-CNN, may be used. Furthermore, as a method of machine learning, a method based on a recurrent neural network (RNN), long short-term memory units (LSTM), which is an extended RNN, or the like may be used if CAN data, for example, temporally continuous time series data, such as a traveling speed, may be used.

The control unit 306 includes a memory and a processor having hardware, such as a CPU. The control unit 306 acquires the price assessment information contributing to the price of the vehicle 10 from the mobile terminal 20 via the network NW, estimates the estimation price information on the vehicle 10 based on the price assessment information, and outputs the estimation price information to the mobile terminal 20. In an embodiment, the control unit 306 functions as a second processor.

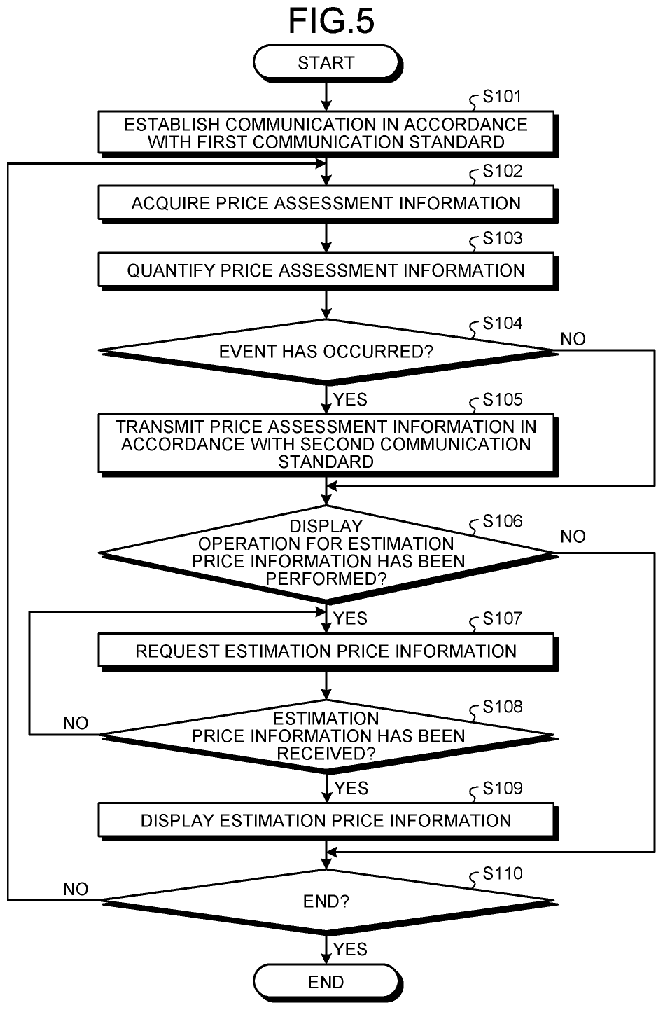

Next, processing to be executed by the mobile terminal 20 will be described. FIG. 5 is a flowchart illustrating an outline of processing to be executed by the mobile terminal 20. Note that, in processing to be executed by the mobile terminal 20, the processing to be executed by the mobile terminal 20 when the estimation price information on the vehicle 10 used by the user is checked via the price assessment server 30 by registering by the user in advance in the price assessment server 30 will be described with reference to FIG. 5.

As illustrated in FIG. 5, the control unit 209 firstly controls the first communication unit 201 to establish communication with the first communication unit 108 of the vehicle 10 in accordance with the first communication standard (Wi-Fi) (step S101). In this case, the user of the mobile terminal 20 operates the operation unit 204 to perform the tethering setting. Specifically, the control unit 209 communicates with a device address of the vehicle 10 selected by the user operating the operation unit 204 from among a plurality of device addresses (IP addresses) displayed on the display unit 203. Then, the control unit 209 compares the password (a plurality of texts) input by the user operating the operation unit 204 with a preset password to establish communication between the first communication unit 201 and the first communication unit 108 of the vehicle 10 when the passwords match each other. Accordingly, the vehicle 10 may wirelessly communicate with the mobile terminal 20 in accordance with the first communication standard. In an embodiment, the vehicle 10 and the mobile terminal 20 are communicably connected by wireless communication, but the present disclosure is not limited thereto, and the vehicle 10 and the mobile terminal 20 may be communicably connected by, for example, wired connection.

Subsequently, the control unit 209 acquires the price assessment information from the vehicle 10 via the first communication unit 201 (step S102). Specifically, the control unit 209 acquires the price assessment information at predetermined time intervals, such as one-minute intervals. Needless to say, the control unit 209 may constantly acquire the price assessment information if the establishment of the communication between the mobile terminal 20 and the vehicle 10 is maintained.

Then, the control unit 209 quantifies the price assessment information acquired from the vehicle 10 via the first communication unit 201 (step S103). Specifically, the control unit 209 estimates, based on the image data, the position information on the vehicle 10, and the time information included in the price assessment information, the parking place of the vehicle 10 and the parking period to quantify the estimation result. More specifically, when estimating that the parking place of the vehicle 10 is near the sea or the parking place has no roof and is exposed to rain and that the parking period is long, the control unit 209 sets the numerical value contributing to the price assessment to be low. For example, when estimating that the parking place of the vehicle 10 is near the sea and that the parking period is long, the control unit 209 performs quantification in such a manner that the numerical value contributing to the price assessment is, for example, 30 points out of 100 points, and when estimating that the parking place of the vehicle 10 is far from the sea and inland and that the parking period is short, the control unit 209 performs quantification in such a manner that the numerical value is 80 points. The control unit 209 further quantifies the driving tendency of the user based on the CAN data of the price assessment information. Specifically, the control unit 209 estimates, based on the detection result of the acceleration sensor 102, the detection results of the accelerator pedal sensor 103 and the brake pedal sensor 104, and the image data included in the CAN data, the roughness of acceleration/deceleration of the vehicle 10, the inter-vehicular distance from the preceding vehicle, the number of times of obstruction of crossing pedestrians to quantify the driving tendency of the user.

Subsequently, the control unit 209 determines whether an event has occurred in the vehicle 10 based on the CAN data included in the price assessment information (step S104). For example, the control unit 209 determines, based on the CAN data, whether the vehicle 10 has performed sudden braking as an event, and determines that the event has occurred in the vehicle 10 when the vehicle 10 has performed sudden braking, or determines that no event has occurred in the vehicle 10 when the vehicle 10 has not performed sudden braking. Note that, the event is any of starting of the vehicle 10, stopping, sudden braking, an accident, reaching a travel distance at which the price decreases, and passing through a predetermined place. Here, the starting of the vehicle 10 is a timing when the ignition key is turned on or the power button is turned on. The stopping of the vehicle 10 is a timing when the ignition key is turned off or the power button is turned off. The accident of the vehicle 10 is a timing at which the acceleration detected by the acceleration sensor 102 exceeds a predetermined threshold or more. The reaching a travel distance of the vehicle 10 at which the price decreases is for example, a timing when the travel distance of the vehicle 10 reaches every 1000 km. The passing of the vehicle 10 through a predetermined place is a timing when the vehicle 10 passes through a place, such as the seaside or a flooded place, that affects the price to purchase and sale the vehicle 10. When the control unit 209 determines that the event has occurred in the vehicle 10 (step S104: Yes), the mobile terminal 20 proceeds to step S105 described later. On the other hand, when the control unit 209 determines that no event has occurred in the vehicle 10 (step S104: No), the mobile terminal 20 proceeds to step S106 described later.

In step S105, the control unit 209 causes the third communication unit 207 to transmit the price assessment information acquired from the vehicle 10 in accordance with the second communication standard based on a mobile phone line. In this case, the control unit 209 performs known encryption processing on the price assessment information and causes the third communication unit 207 to transmit it. Needless to say, the control unit 209 may perform compression processing or the like on the price assessment information in addition to the known encryption processing.

Subsequently, the control unit 209 determines whether the user has operated the operation unit 204 for a display operation for checking the estimation price information on the vehicle 10 (step S106). Specifically, the control unit 209 determines, based on an operation signal input from the operation unit 204, whether the user has touched an icon corresponding to an application (App) for checking the estimation price information on the vehicle 10 displayed on the display unit 203 by the user operating the operation unit 204. When the control unit 209 determines that the user has operated the operation unit 204 for the display operation for checking the estimation price information on the vehicle 10 (step S106: Yes), the mobile terminal 20 proceeds to step S107 described later. On the other hand, when the control unit 209 determines that the user has not operated the operation unit 204 for the display operation for checking the estimation price information on the vehicle 10 (step S106: No), the mobile terminal 20 proceeds to step S110 described later.

In step S107, the control unit 209 causes the third communication unit 207 to transmit a request signal for requesting the price assessment server 30 to transmit the estimation price information on the vehicle 10. The request signal includes a device address for identifying the mobile terminal 20, registration information (login information) registered in the price assessment server 30, a password for accessing the price assessment server 30, and the like.

Then, the control unit 209 determines whether the third communication unit 207 has received the estimation price information from the price assessment server 30 (step S108). When the control unit 209 determines that the third communication unit 207 has received the estimation price information from the price assessment server 30 (step S108: Yes), the mobile terminal 20 proceeds to step S109 described later. On the other hand, when the control unit 209 determines that the third communication unit 207 has not received the estimation price information from the price assessment server 30 (step S108: No), the mobile terminal 20 returns to step S107.

In step S109, the control unit 209 causes the display unit 203 to display the estimation price information on the vehicle 10 received by the third communication unit 207 from the price assessment server 30.

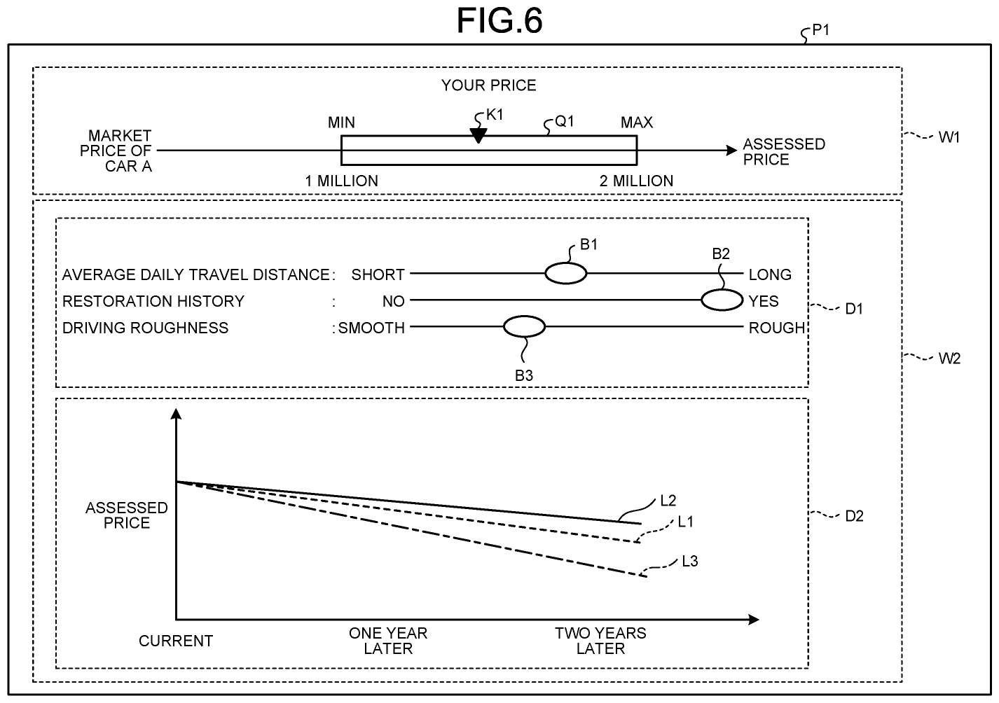

FIG. 6 is a diagram illustrating an example of the estimation price information on the vehicle 10 displayed by the display unit 203. Estimation price information P1 illustrated in FIG. 6 includes price information W1 and price transition information W2. The price information W1 includes a market price of the model (car A) of the vehicle 10 used by the user, an assessment price Kl of the current vehicle 10, and an assessment range Ql indicating a minimum value (MIN) and a maximum value (MAX) of the assessment price. The price transition information W2 includes a driving tendency D1 of the user and a price transition D2 based on the driving tendency of the user. The driving tendency D1 of the user includes an average daily travel distance, a restoration history, and driving roughness. The driving tendency D1 further includes a seek bar corresponding to each of the average daily travel distance, the restoration history, and the driving roughness. In addition, the price transition D2 includes future price transitions L1 to L3 that change in conjunction with sliders B1 to B3 of the seek bars. The price transition L1 indicates a case where a time elapses with the current driving tendency. The price transition L2 indicates a case where a time elapses with the best driving tendency. The price transition L3 indicates a case where a time elapses with the worst driving tendency.

In this manner, the user may grasp the assessed price of the current or future vehicle 10 by checking the estimation price information P1 displayed by the display unit 203. Note that, the estimation price information P1 is merely an example, and various changes and additions may be made. For example, the estimation price information P1 may include an average market price of the model, a transaction result, or the like.

Returning to FIG. 5, the description of step S110 and subsequent steps will be continued.

In step S110, the control unit 209 determines whether an end signal for ending the check of the estimated price of the vehicle 10 has been input from the operation unit 204. When the control unit 209 determines that the end signal for ending the check of the estimation price information on the vehicle 10 has been input from the operation unit 204 (step S110: Yes), the mobile terminal 20 terminates this processing. On the other hand, when the control unit 209 determines that the end signal for ending the price of the estimation price information on the vehicle 10 has not been input from the operation unit 204 (step S110: No), the mobile terminal 20 returns to step S102.

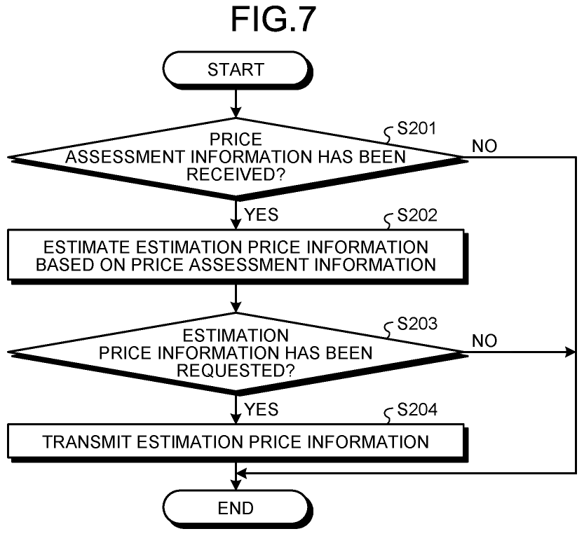

Next, processing to be executed by the price assessment server 30 will be described. FIG. 7 is a flowchart illustrating an outline of processing to be executed by the price assessment server 30.

As illustrated in FIG. 7, the control unit 306 determines whether the communication unit 301 has received the price assessment information on the vehicle 10 from the mobile terminal 20 (step S201). When the control unit 306 determines that the communication unit 301 has received the price assessment information on the vehicle 10 from the mobile terminal 20 (step S201: Yes), the price assessment server 30 proceeds to step S202 described later. On the other hand, when the control unit 306 determines that the communication unit 301 has not received the price assessment information on the vehicle 10 from the mobile terminal 20 (step S201: No), the price assessment server 30 terminates the processing.

In step S202, the control unit 306 estimates the estimation price information on the vehicle 10 based on the price assessment information received by the communication unit 301. Specifically, the control unit 306 estimates the estimation price information on the vehicle 10 based on the price assessment information and the inference unit 305. Specifically, the control unit 306 inputs the price assessment information to the inference unit 305 as input data, acquires output data output from the inference unit 305, and estimates the acquired output data as the estimation price information on the vehicle 10.

Subsequently, the control unit 306 determines whether a request signal for requesting the estimation price information on the vehicle 10 has been input from the mobile terminal 20 via the communication unit 301 (step S203). When the control unit 306 determines that the request signal for requesting the estimation price information on the vehicle 10 has been input from the mobile terminal 20 via the communication unit 301 (step S203: Yes), the price assessment server 30 proceeds to step S204 described later. On the other hand, when the control unit 306 determines that the request signal for requesting the estimation price information on the vehicle 10 has not been input from the mobile terminal 20 via the communication unit 301 (step S203: No), the price assessment server 30 terminates the processing.

In step S204, the control unit 306 causes the communication unit 301 to transmit the estimation price information to the mobile terminal 20. After step S204, the price assessment server 30 terminates the processing.

According to the embodiment described above, the control unit 209 acquires price assessment information contributing to the price of the vehicle 10 from the vehicle 10, determines whether an event has occurred in the vehicle 10 based on the price assessment information, and outputs the price assessment information to the price assessment server 30 when the event has occurred in the vehicle 10. Accordingly, it is possible to reduce the initial cost of an in-vehicle communication module and to reduce the financial burden of the communication cost on the user.

In addition, according to the embodiment, the event at the timing when the control unit 209 transmits the price assessment information to the price assessment server 30 is any of starting of the vehicle 10, stopping, sudden braking, an accident, reaching a travel distance at which the price decreases, and passing through a predetermined place. Accordingly, the mobile terminal 20 does not constantly transmit the price assessment information to the price assessment server 30 via a mobile phone line, and it is possible to reduce the financial burden of the communication cost on the user.

In addition, according to the embodiment, the price assessment information includes any one or more pieces of travel data of the vehicle 10, CAN data, travel distance data, model year data, image data, odor data indicating an odor in a vehicle interior of the vehicle 10, scratch data as to whether there is a scratch, driving tendency data of the user of the vehicle 10, parking place data of the vehicle 10, and parking period data at a parking place of the vehicle 10, and it is possible to output the data contributing to the price assessment of the vehicle 10 to the price assessment server 30.

Furthermore, according to the embodiment, the control unit 209 estimates the driving tendency of the user of the vehicle 10 based on the CAN data, and it is possible to output the price assessment information reflecting the usage condition other than the appearance of the vehicle 10 to the price assessment server 30.

Furthermore, according to the embodiment, the control unit 209 estimates the parking place of the vehicle 10 and the parking period of the vehicle 10 based on the image data, and it is possible to transmit the price assessment information reflecting the actual usage condition of the vehicle 10 to the price assessment server 30.

Furthermore, according to the embodiment, the control unit 209 acquires the price assessment information from the vehicle 10 in accordance with a first wireless communication standard (Wi-Fi) and outputs the price assessment information acquired from the vehicle 10 to the price assessment server 30 in accordance with a second wireless communication standard (communication standard using a mobile phone line) different from the first wireless communication standard, and it is possible to reduce the initial cost of the in-vehicle communication module and to reduce the financial burden of the communication cost on the user.

Furthermore, according to the embodiment, the control unit 209 acquires, from the price assessment server 30, estimation price information on the vehicle 10 estimated by the price assessment server 30 and outputs the estimation price information to the display unit 203, and it is possible for the user to intuitively grasp the current assessed price of the vehicle 10.

Furthermore, according to the embodiment, the control unit 306 acquires, from the mobile terminal 20, the price assessment information contributing to the price of the vehicle 10 and estimates the estimation price information on the vehicle 10 based on the price assessment information. Then, the control unit 306 outputs the estimation price information to the mobile terminal 20, and it is possible to assess the price of the vehicle in consideration of the storage condition of the vehicle 10 and the driving content of the user.

Furthermore, according to the embodiment, the price assessment information includes any one or more pieces of the travel data of the vehicle 10, the CAN data, the travel distance data, the model year data, the image data, the odor data indicating the odor in the vehicle interior of the vehicle 10, the scratch data as to whether there is a scratch, the driving tendency data of the user of the vehicle 10, the parking place data of the vehicle 10, and the parking period data at the parking place of the vehicle 10, and it is possible to assess the price of the vehicle in consideration of the storage condition of the vehicle 10 and the driving content of the user.

Furthermore, according to the embodiment, the estimation price information includes a current assessed price and a future assessed price of the vehicle 10. Thus, it is possible for the user to grasp the user's current situation and current driving tendency.

In addition, in the price assessment system, the term “unit” may be replaced with “circuit” or the like. For example, the control unit may be replaced with a control circuit.

In addition, the program to be executed by the price assessment system is provided as file data in an installable format or in an executable format by being recorded in a computer-readable recording medium, such as a CD-ROM, a flexible disk (FD), a CD-R, a digital versatile disk (DVD), a USB medium, or a flash memory.

The program to be executed by the price assessment system according to the embodiment may be stored in a computer connected to a network, such as the Internet, and provided by being downloaded via the network.

Note that, in the description of the flowcharts in this specification, the processing order of the steps is clearly described using the expressions of “first”, “then”, “subsequently”, and the like, but the order of processing to implement an embodiment is not uniquely determined by these expressions. That is, the order of the processing in the flowcharts described in this specification may be changed within a range without inconsistency.

According to the present disclosure, it is possible to reduce the initial cost for an in-vehicle communication module and to reduce a financial burden of the communication cost on a user.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile terminal comprising
a processor comprising hardware, the processor being configured to:
acquire, from a vehicle, price assessment information contributing to a price of the vehicle;
determine, based on the price assessment information, whether an event has occurred in the vehicle; and
output, in a case where the event has occurred in the vehicle, the price assessment information to a vehicle assessment server configured to assess the vehicle.

2. The mobile terminal according to claim 1, wherein the event is any one of: starting of the vehicle; stopping; sudden braking; an accident; reaching a travel distance at which the price decreases; and passing through a predetermined place.

3. The mobile terminal according to claim 1, wherein the price assessment information includes one or more pieces of: travel data of the vehicle; CAN data; travel distance data; model year data; image data; odor data indicating an odor of a vehicle interior of the vehicle; scratch data as to whether there is a scratch; driving tendency data of the user of the vehicle; parking place data of the vehicle; and parking period data at a parking place of the vehicle.

4. The mobile terminal according to claim 3, wherein the processor is configured to estimate, based on the CAN data, a driving tendency of the user of the vehicle.

5. The mobile terminal according to claim 3, wherein the processor is configured to estimate, based on the image data, the parking place and the parking period at the parking place of the vehicle.

6. The mobile terminal according to claim 1, wherein the processor is configured to:
acquire the price assessment information from the vehicle in accordance with a first wireless communication standard; and
output the price assessment information to the vehicle assessment server in accordance with a second wireless communication standard different from the first wireless communication standard.

7. The mobile terminal according to claim 1, wherein the processor is configured to:
acquire, from the vehicle assessment server, estimation price information on the vehicle estimated by the vehicle assessment server; and
output the estimation price information on a display.

8. A price assessment system comprising:
a mobile terminal comprising a first processor comprising hardware; and
a vehicle assessment server comprising a second processor comprising hardware, wherein
the first processor is configured to:
acquire, from a vehicle, price assessment information contributing to a price of the vehicle;
determine, based on the price assessment information, whether an event has occurred in the vehicle; and
output, when the event has occurred in the vehicle, the price assessment information to the vehicle assessment server.

9. A non-transitory computer-readable recording medium on which an executable program is recorded, the program causing a processor of a computer to execute:
acquiring, from a vehicle, price assessment information contributing to a price of the vehicle;
determining whether an event has occurred in the vehicle; and
outputting, when the event has occurred in the vehicle, the price assessment information to a vehicle assessment server configured to assess the vehicle.
